(19) United States
(12) Patent Application Publication
(10) Pub. No.: US 2007/0020996 A1
(43) Pub. Date: Jan. 25, 2007

(54) Housing Duct

(76) Inventor: Dietmar Kurzeja, Malsch (DE)

Correspondence Address: BARLEY SNYDER, LLC, 1000 WESTLAKES DRIVE, SUITE 275, BERWYN, PA, 19312, US

(21) Appl. No.: 11/457,193

(22) Filed: Jul. 13, 2006

(30) Foreign Application Priority Data
Jul. 20, 2005 (DE) 102005033912.3

(51) Int. Cl. H01R 13/40

(52) U.S. Cl. 439/587

(57) ABSTRACT

A housing duct comprises a housing and a conductor element. The housing has a sealing region. The conductor element is embedded in at least the sealing region of the housing. The conductor element has an electroplated fissured surface structure in at least the sealing region.

### FIELD OF THE INVENTION

The invention relates to a housing duct for electronic connections and to a method for producing the same.

### BACKGROUND OF THE INVENTION

United States Patent Application Publication No. 2004/0192117 shows an example of a housing duct. The housing duct consists of an electrical conductor having a profiled portion molded in a plastic material that forms a housing. During the molding process, the plastic material is deposited in indentations of the profiled portion and thus fixes the conductor in the housing. The profiling of the electrical conductor is also used to seal the housing duct. The boundary between the electrical conductor and the plastic material is enlarged by the profiling. The path which a penetrating liquid or other substance must take in order to reach an interior of the housing is therefore also lengthened. A plurality of shoulders and edges inside the profiled portion constitute an additional obstacle for the penetrating medium. The profiling of the conductor thus acts as a torturous seal.

One drawback of a torturous seal of this type is its length. Torturous seals can require relatively long profiled portions, depending on the required degree of tightness needed to protect against splashed water, solvent, or even gas. Because the torturous seal must be long, the dimensions of the housing are resultantly very large. As profiling of the electrical conductor usually takes place by complex manufacturing methods, such as by stamping or milling, production of torturous seals is also expensive. Additionally, because the metallic electrical conductor and the plastic material of the housing have different coefficients of expansion, the plastic material expands significantly faster than the metallic material. As a result, the capillary or sealing gap between the electrical conductor and the plastic material of the housing, which proves to be adequate at a predetermined temperature, can be increased by temperature elevation causing the torturous seal to no longer provide adequate protection.

U.S. Pat. No. 2,438,993 describes a flash lamp that also comprises a housing lead-through of the type mentioned at the outset. In this example, a boundary between a housing and a conductor element is sealed with a cellulose layer. Introduction of the cellulose layer not only requires a further separate component but also additional working steps. In addition, the cellulose layer is often not sufficient enough to withstand current quality requirements with respect to tightness and fire protection.

### BRIEF SUMMARY OF THE INVENTION

It is an object of the invention to provide a housing duct and a method for producing a housing duct such that, despite a simple construction, the housing duct is sealed against penetration of undesirable substances and is also easy to produce.

This and other objects are achieved by a housing duct comprising a housing and a conductor element. The housing has a sealing region. The conductor element is embedded in at least the sealing region of the housing. The conductor element has an electroplated fissured surface structure in at least the sealing region.

This and other objects are further achieved by a method for producing a housing duct comprising the steps of: electroplating a conductor element to have a fissured surface structure; and embedding at least the surface structure of the conductor element in at least a sealing region of a housing.

### BRIEF DESCRIPTION OF THE DRAWINGS

FIG. 1 is a partial open side view of a housing duct according to the invention.

FIG. 2 is a cross-sectional view through a sealing region of the housing duct according to the invention.

FIG. 3 is a schematic diagram of an electroplating process according to the invention.

### DETAILED DESCRIPTION OF THE INVENTION

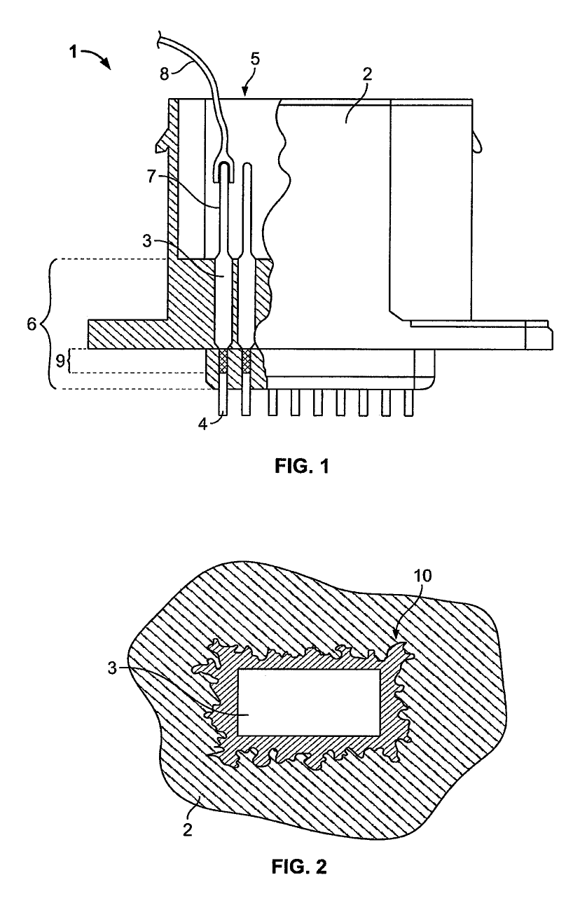

FIG. 1 shows a housing duct 1 according to the invention. The housing duct 1 is illustrated as a connector herein. The term “connector” includes both male and female connectors, although the invention will be described herein with reference to a male connector.

As shown in FIG. 1, the housing duct 1 comprises a housing 2 provided with a plurality of conductor elements 3. The conductor elements 3 are embedded in a portion 6 of the housing 2 to fix the conductor elements 3 to the housing 2, as shown in the partial sectional view of the housing 2 at reference numeral 5. The conductor elements 3 have free ends 4 that project from a bottom surface of the housing 2 and laid open ends 7 inside the housing 2 that are connected to electrical lines 8. A sealing region 9 is provided in the portion 6 of the housing 2 and prevents the penetration of undesirable substances into the housing 2 along a boundary between the conductor element 3 and the housing 2.

As shown in FIG. 2, the conductor element 3 has a substantially rectangular cross-section. It will be appreciated by those skilled in the art, however, that other cross-sectional shapes are also possible, such as round, oval or square cross-sectional shapes. The conductor element 3 includes a roughened, fissured surface structure 10 with a plurality of peaks and valleys (shown enlarged in FIG. 2). The surface structure 10 may be produced, for example, by electroplating the conductor element 3 with a coating material 11. The coating material 11 may contain, for example, tin. Alternatively or in addition thereto, the coating material 11 may contain zinc, copper, gold, silver, nickel and/or chromium.

The structure surface 10 has a peak-to-valley height increased by electroplating in the sealing region 9. The peak-to-valley height of the surface structure 10 is approximately 15 μm. The peak-to-valley height of the conductor element 3 in the sealing region may be varied, however, in the range of 5 to 40 μm, preferably 10 to 30 μm and in particular 10 to 20 μm depending on the desired sealing properties. In the illustrated embodiment, the peak-to-valley height is substantially constant over the entire sealing region 9 and is formed by electroplating an annular portion of the conductor element 3. It will be appreciated by those skilled in the art, however, that embodiments in which the peak-to-valley height varies inside the sealing region 9 are also conceivable. For example, a plurality of mutually spaced apart annular zones with increased peak-to-valley height could be provided in the sealing region 9. In addition, the entire conductor element 3, instead of just a portion, as illustrated herein, may alternatively first be electroplated before it is processed further. The desired peak-to-valley height, as well as the characteristics of the peak-to-valley height over the entire surface of the conductor element 3, may be adjusted depending on the desired sealing properties by way of the following parameters: concentration, circulation and current density.

When extrusion coating or molding the conductor element 3 with the material of the housing 2, the material of the housing 2 flows into indentations and edges of the surface structure 10. Securing of the housing material in the numerous indentations and edges of the surface structure 10 fixes the conductor element 3 in the housing 2 so that the conductor element 3 can not be moved from its position if a force acts thereon. A secure bond, which efficiently seals the housing duct 1, is therefore produced. This securing of the housing material also ensures good sealing of the housing duct 1 against the penetration of undesirable substances. Additionally, because the housing material completely fills the indentations of the surface structure 10, even in the event of variations in temperature that cause the material of the housing 2 and the conductor element 3 to expand, the material of the housing 2 spreads into the indentations and edges of the surface structure 10 and thus ensures a tight seal of the housing duct 1.

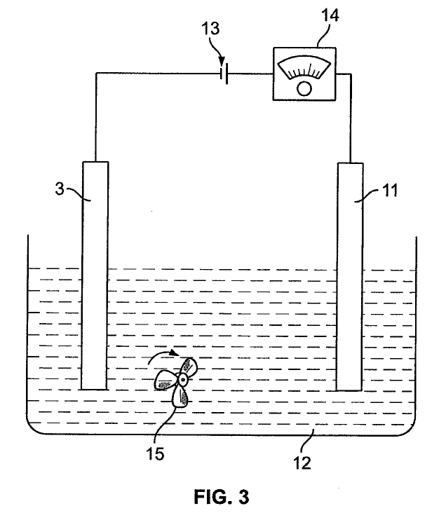

FIG. 3 is a schematic illustration of the electroplating process according to the invention. As shown in FIG. 3, the coating material 11, which is in the form of an electrode, and the conductor element 3 are immersed in an electroplating or electrolyte bath 12. The conductor element 3 and the coating material 11 are connected to a power source 13. The coating material 11 is located at a positive pole (the anode) and the conductor element 3 that is to be coated is located at a negative pole (the cathode). Current flows through the electroplating bath 12 by applying an electrical current to the conductor element 3 and the coating material 11. The current can be measured or adjusted using a current measuring device 14, which also allows the current intensity to be regulated. A circulating mechanism 15 allows thorough mixing of the electroplating bath 12. At the same time, rinsing of the electroplating bath 12 may be provided by way of the circulating mechanism 15.

The required peak-to-valley height may be controlled during the electroplating process, in particular by way of the following process parameters: concentration of the coating material 11 that is to be deposited in the electroplating bath 12, circulation or rinsing of the electroplating bath 12, and the current density applied. For example, a reduced concentration of the coating material 11 with, at the same time, constant or even increased current density, produces an uneven, rough surface, because compared with the layer growth caused by the current density, there are too few coating material atoms or molecules. The same applies to the circulation of the electroplating bath 12. As a result of a lower degree of circulation, fewer particles of the coating material 11 that are to be deposited arrive at the negative pole. With a uniformly high current density, an imperfect, and therefore rough, surface is produced in this case as well.

Stabilizers may be added to the electroplating bath 12 to achieve a uniform concentration distribution within the electroplating bath 12 and/or to prevent undesirable processes in the bath, such as decomposing. Additionally, brighteners, which are added to conventional electroplating baths to obtain optimally smooth and therefore high luster surfaces, can be omitted to assist in the formation of the uneven surface.

The increased peak-to-valley height ensures improved adhesion between the housing material and the conductor element 3. This increased peak-to-valley height is achieved, contrary to the established application, by electroplating. Although electroplating has been used to date only for surface coating, and therefore for the reduction of the peak-to-valley height of surfaces, it is used in this case for the opposite purpose. The electroplating process is used here, contrary to previously conventional methods, to produce a fissured surface structure on the conductor element 3. These peak-to-valley heights may be efficiently produced by electroplating and ensure a seal.

In a particular embodiment of the invention, the peak-to-valley height of the conductor element can be increased by controlling the circulation and/or rinsing in the electroplating bath. Less material, which is to be deposited, passes from anode to cathode as a result of low circulation or good rinsing in contrast to previous electroplating processes in this field. The peak-to-valley height produced as a result of the electroplating process may thus be efficiently controlled.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A housing duct, comprising:
a housing having a sealing region; and
a conductor element embedded in at least the sealing region of the housing, the conductor element having an electroplated fissured surface structure in at least the sealing region.

2. The housing duct of claim 1, wherein the surface structure has a peak-to-valley height in the sealing region in the range of 5 to 40 μm.

3. The housing duct of claim 2, wherein the peak-to-valley height in the sealing region is in the range of 10 to 30 μm.

4. The housing duct of claim 3, wherein the peak-to-valley height in the sealing region is in the range of 10 to 20 μm.

5. The housing duct of claim 1, wherein the conductor element is electroplated with a coating material containing tin, zinc, copper, gold, silver, nickel or chromium.

6. The housing duct of claim 1, wherein the conductor element has a free end projecting from a bottom surface of the housing and a laid open end inside the housing.

7. The housing duct of claim 6, wherein the sealing region is between the free end and the laid open end.

8. The housing duct of claim 1, wherein the surface structure has a constant peak-to-valley height over the entire sealing region.

9. The housing duct of claim 1, wherein the housing and the conductor element have different coefficients of expansion.

10. A method for producing a housing duct, comprising the steps of:
electroplating a conductor element to have a fissured surface structure; and
embedding at least the surface structure of the conductor element in at least a sealing region of a housing.

11. The method of claim 10, wherein the surface structure has a peak-to-valley height in the sealing region in the range of 5 to 40 μm.

12. The method of claim 1 1, wherein the peak-to-valley height in the sealing region is in the range of 10 to 30 μm.

13. The method of claim 12, wherein the peak-to-valley height in the sealing region is in the range of 10 to 20 μm.

14. The method of claim 10, wherein the conductor element is electroplated with a coating material containing tin, zinc, copper, gold, silver, nickel or chromium.

15. The method of claim 10, wherein the conductor element has a free end projecting from a bottom surface of the housing and a laid open end inside the housing, the sealing region being positioned between the free end and the laid open end.

16. The method of claim 10, wherein the surface structure has a constant peak-to-valley height over the entire sealing region.

17. The method of claim 10, wherein the housing and the conductor element have different coefficients of expansion.

18. The method of claim 10, further comprising the step of immersing the conductor element in an electroplating bath.

19. The method of claim 18, further comprising the step of reducing a concentration of a coating material in the electroplating bath while increasing current density.

20. The method of claim 18, further comprising the step of reducing circulation in the electroplating bath while increasing current density.

21. The method of claim 18, further comprising the step of adding stabilizers to the electroplating bath.
